(19) United States
(12) Patent Application Publication
(10) Pub. No.: US 2010/0276441 A1
(43) Pub. Date: Nov. 4, 2010

(54) REDUCED FLOW SALT SHAKER

(76) Inventors: WILLIAM T. PORDY, BROOKLYN, NY (US); CLAY ALLEN BURNS, NEW YORK, NY (US); JAIME URIBARRI, NEW YORK, NY (US)

Correspondence Address: MCKEE, VOORHEES & SEASE, P.L.C., 801 GRAND AVENUE, SUITE 3200, DES MOINES, IA, 50309-2721, US

(21) Appl. No.: 12/432,316

(22) Filed: Apr. 29, 2009

(51) Int. Cl. A47G 19/24; B67D 7/06

(52) U.S. Cl. 222/1; 222/565; 222/547; 222/564

(57) ABSTRACT

A dispenser for salt or other dry granulated material includes a combination of a container, a sprinkling cap and a flow-reducing element located between the sprinkling cap and an opening of the container. The flow-reducing element includes openings such that it allows fewer granules to pass when the container is inverted and shaken than would otherwise be allowed by the sprinkling cap alone. The combination of the sprinkling cap and the internal flow-reducing element provide the function of evenly releasing and distributing the granules in an expected and continuous manner, yet at a significantly lower rate than standard dispensers.

### FIELD OF THE INVENTION

The field of the invention is dispensers of granular or powered materials, and more particularly to shakers of salt, sugar, spice, and related condiments.

### BACKGROUND OF THE INVENTION

For a number of decades there has been a slow and steady movement to reduce the amount of sodium consumed by the average person. The effects of a high sodium diet have attracted much attention in recent years, with escalating data on the connection between salt and high blood pressure, heart disease, and kidney disease. The average daily intake of salt is 10-12 grams (4,000-4,800 mg sodium) in the United States and most industrialized countries. Local and national policies and programs, as well as international policies and programs, have begun to restrict the sodium levels in prepared foods. While the majority of salt in the American and Western diets comes from processed and prepared foods, 10-30% of the daily salt intake comes from salt added at the table (and approximately 10-12% comes from salt naturally occurring in foods).

In addition to the efforts noted above, there is a need for a dispensing device that helps consumers reduce their individual sodium intake when salting foods. This has been confirmed by recent data presented at the 2009 American Heart Association annual meeting showing that even a one gram reduction in daily salt intake is associated with substantial health benefits.

While some products have attempted to address this issue, the vast majority of salt shakers on the market today comprise standard shakers with perforated tops that, with a few shakes, dispense as much as 1,000 mg of salt (390 mg of sodium) per use. Furthermore, a large dose of salt often masks the flavor of the food, much of which is already high in sodium, and leads people to become accustomed to a very salty taste. Therein lies the problem as the total recommended daily allowance of sodium is 2,400 mg, and 1,500 mg of sodium for the more than 75 million Americans suffering from hypertension.

Clearly administering fewer or softer shakes with a standard salt shaker could serve to reduce the amount of salt applied. However, most people shake several times—typically 5-9—partly out of habit and conditioning, and partly as a means to adequately disperse the salt over the plate of food. Maintaining this expected shaking behavior and user control is important. The problem is that, in an effort to adequately disperse the salt, a standard shaker provides too much salt per shake. There are some obvious possible remedies. Reducing the size of the perforations limits the amount of salt dispensed, but invites erratic flow and clogging, because the holes become close to the size of the salt crystals. Using fewer perforations is another possibility, but is also problematic because the expected sprinkling action is lost—only a trickle of salt is dispensed. Other solutions attempting to reduce or control the flow of salt in a dispensing device have failed in the market because they are often non-intuitive, require additional steps, or are overly complex. A reduced-flow salt dispenser should preferably be similar in function, appearance, and operation and as easy to use to what people use today.

The prior patented art related to this invention comprises primarily metering and dosing devices. Some solutions are devices that require an additional action to deliver a preset dose, such as twisting or pushing a lever. These are not readily adopted by the market because of the additional user action required and their relative cost and complexity compared with a standard salt shaker. Some other failings of these devices are that they vary from dose to dose and can invite jamming due to their mechanisms. Other devices use an internal tube, cavity, or chamber that allows a nominal amount of granulated material to reach the dispensing area when the shaker is inverted. These devices are common in sugar dispensers, where roughly a teaspoon is dispensed each time the container is inverted. While this solution has been adapted in the past for salt shakers, the preferred action for salt is multiple vertical shakes, taps, or waves, rather than a single dumping action as with sugar. Other inventions comprise a mix of unrelated unique solutions.

### SUMMARY OF THE INVENTION

What is needed is a device that improves people's health while not depriving them of the spontaneous use of a simple shaker to enhance the flavor of food. This invention overcomes the limitations of the current art described above, providing a salt dispenser that employs a natural shaking action, a normal sprinkling pattern, and a reduced amount of salt when shaken an average number of times.

Therefore, it is an object of this invention to provide a means for dispensing a reduced amount of salt while maintaining the action, ease of use, and identity of a standard salt shaker.

It is another object of this invention to permit the use of a standard salt shaker while allowing the benefits of a reduced sodium intake.

It is another object of this invention to provide a reduced-flow salt shaker that allows the user to easily and ultimately control how much salt they want.

Another object of this invention is to provide a device that works for different types of shaking, such as vertical, side-to-side, tapping and the like.

It is a further object of this invention to employ a standard perforated cap, for effective sprinkling over food area.

Another object of this invention is to provide a simple solution and assembly, so that the device can be adapted to a number of shaker sizes, designs, or embodiments, for example a small personal shaker or one containing a daily or weekly amount of salt.

It is another object of this invention to provide a device that can be adapted to a variety of flows for a specified number of shakes (for example, in one embodiment 10 shakes will deliver no more than 35 mg of sodium, designated a very low serving of sodium by the FDA).

It is still another objective to provide a device that can be used with a variety of granulated materials, such as sugars or spices, and with different types and sizes of salt.

It is another object of this invention to provide a salt shaker which avoids clumping.

It is also an object of the invention to allow for easy filling, cleaning, and storage.

### BRIEF DESCRIPTION OF DRAWINGS

FIG. 1 is a cross-section view of one embodiment of a dispenser according to the present invention.

FIG. 2 is an exploded view of the dispenser of FIG. 1.

FIG. 3 is a flow-reducing element that uses a mesh screen for use in an alternative embodiment of a dispenser according to the present invention.

FIG. 4 is a cross-section view of a flow-reducing element that includes a visual identification flange for use in a dispenser according to another embodiment of the present invention.

FIG. 5 is a perspective view of a flow-reducing element that permits adjustment of the flow rate by a user according to another embodiment of the present invention.

FIG. 6 is a perspective view of an embodiment of a flow-reducing element with protrusions for helping to break up any clumped granules according to another embodiment of the present invention.

FIG. 7 is a cross-sectional view of the flow-reducing element with protrusions of FIG. 6.

### DETAILED DESCRIPTION OF PREFERRED EMBODIMENTS

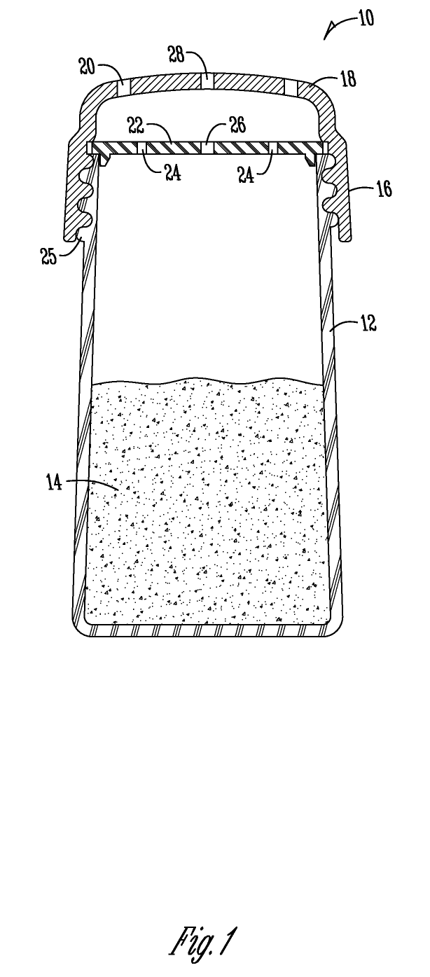

FIG. 1 shows a cross-sectional view of a dispenser 10 according to one embodiment of the present invention. FIG. 2 shows an exploded view of the dispenser 10 from FIG. 1. As seen in FIGS. 1 and 2, the dispenser 10 includes a container 12 that is an open-ended receptacle for holding granulated material 14 such as salt, sugar, spices, or the like. The dispensers disclosed herein may also be suitable for use with viscous fluids such as syrup, honey, or glazes. Such containers are commonly made of glass or plastic, but may be constructed of various materials, including metal, wood, or ceramic. A cap 16 affixes to the open end of container 12 using a screw thread 25, snap fit, or other suitable means known in the art. Preferably cap 16 will be removable from the container 12, to permit filling the container 12 with the granulated material 14, although the invention will work with embodiments where the cap is not removable such as where the cap and container are formed from a single piece. Cap 16 is preferably made from metal or plastic, but may also be constructed from other common materials. Cap 16 has a top wall 18 that includes a plurality of openings 20 that are typically 1-2 millimeters in diameter and distributed approximately evenly across the top wall 18. When the container 12 is inverted and shaken the granules or powder within the container 12 flow through the openings 20 in a sprinkling manner.

Flow-reducing element 22 is located proximate to, but spaced apart from, the inner surface of top wall 18 of cap 16. Preferably there is a space provided between the flow-reducing element 22 and the top wall 18. Element 22 may be made from plastic, metal, or other suitable material. Element 22 allows a smaller amount of granulated material 14 to pass through it into the area of cap 16 when container 12 is inverted and shaken, than is allowed without the flow-reducing element 22. Accordingly the rate of flow is controlled by flow-reducing element 22, rather than by cap 16 whose primary function in this invention is to sprinkle evenly, rather than to control the rate of flow. Having two perforated areas with a space between them provides a mechanism for reducing the amount of granulated material dispensed, while maintaining an expected sprinkling pattern. The flow-reducing element 22 acts as a barrier that prevents the free flow of granular material from the container to the openings 20 in the cap 16. The combination of the sprinkling cap 16 and the internal flow-reducing element 22 provide the function of evenly releasing and distributing the granules 14 in an expected and continuous manner: shake, sprinkle, tap or wave yet at a significantly lower rate than standard dispensers.

In one embodiment, flow-reducing element 22 has five holes 24 of diameter 0.9-1.4 millimeters, whose combination provides an average of less than 35 mg of sodium when the container is inverted and shaken 10 times. This is approximately one-seventh the dose of sodium dispensed by the standard salt shaker on the market today for a comparable amount of shakes. In a preferred embodiment, one hole 26 is located in the center of flow-reducing element 22, such that it aligns with an opening 28 in the center of cap 16. This center hole 26 in the flow-reducing element 22 has a diameter of approximately 1.34 millimeters, slightly larger than the four surrounding holes 24 of 1.1 millimeters. The larger center hole 26 is in alignment with the center opening 28 in the cap 16 to help prevent a slight delay that may occur during the first shake, where the granules 14 bounce around inside the area between flow-reducing element 22 and cap 16 before they find their way out through the openings 20 and 28.

It will be clear to those skilled in the art that the rate of flow may vary quite easily by changing the size and amount of holes in the flow-reducing element 22. For example, three holes of the appropriate diameter may adequately perform the flow-reducing function. In theory even one hole of the appropriate diameter can provide the same flow rate as three holes whose area adds up to that of the one hole. While this theory applies well to fluids or powders, granules do not flow as easily as fluid. The openings must take into account crystal size, friction, micro-clogging and irregularity. A single hole of the minimum size needed to allow crystals to pass yields a flow rate that is much too low, while a large hole can lead to a pouring condition, where crystals rush through continuously. It is more reliable to use a plurality of holes in the flow-reducing element 22 to accomplish the desired flow rate.

It is desirable that flow-reducing element 22 be removable for cleaning, replacement, or substitution with another part that provides a different flow rate. In the preferred embodiment, element 22 is interference fit into the top opening 30 of container 12 using flanges 32. Those skilled in the art will understand that the same effect may be accomplished using other means, such as screw threads, a snap fit or press fit. Alternatively, flow-reducing element 22 may be designed such that it attaches to the inside of cap 16 as opposed to attaching to the container 12.

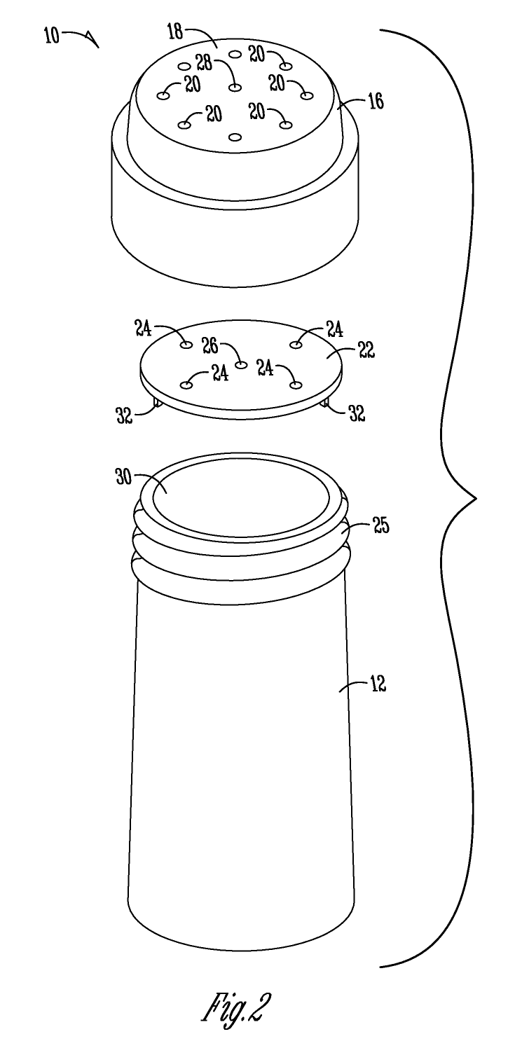

In FIG. 3, an alterative embodiment of a flow-reducing element 122 is shown that is similar to element 22, except that the holes for passing granulated material are replaced by a screen 34, made of wire, mesh, webbing, or the like.

In FIG. 4, a cross-section of another embodiment of a flow-reducing element 222 is shown attached to a cap 16. Flow-reducing element 222 includes an extended cylindrical base 36 that is threaded on its inside and outside surfaces for connection to the cap 16 and to a container (not shown). The base 36 has a flange 38 at its open end such that when the flow-reducing element 222 is assembled with container and cap 16, the flange 38 is visible to a user. Therefore a user will be aware that the dispenser 10 includes a flow-reducing element. As shown in FIG. 4, flange 38 is annular, but it could be a tab or other structure. Flange 38 may be attributed a color or marking to provide a convenient way for the consumer to identify the dispenser as a reduced-flow dispenser, and also serves as a means for removing and re-inserting flow-reducing element 22 from cap 16 by grasping the flange and twisting. It should be appreciated that instead of threaded attachment to the cap 16 and the container, flow-reducing element 222 could be provided with means for a friction fit, snap fit, or other known attachment mechanism. It also contemplated that other visual identification structures might be used to identify the dispenser as a low-flow dispenser. For example, an external band, such as a colored rubber band embossed with writing, might be included that wraps around the container or the cap to provide notice that a flow-reducing element is included in the dispenser.

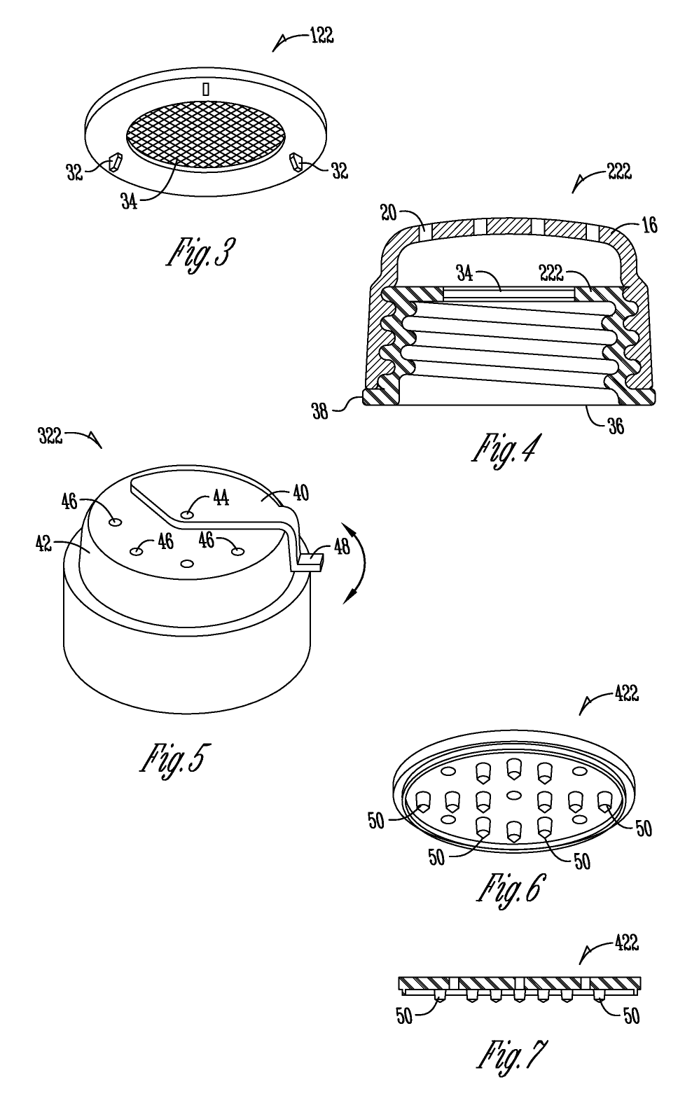

In FIG. 5, another embodiment of a flow-reducing element 322 is shown that includes an adjustment feature to adjust the rate of flow allowed by the flow-reducing element. Shutter 40 is pivotally attached to body 42 at pivot member 44. The body 42 includes a plurality of openings 46 for permitting flow of granular material as described above. Shutter 40 has a pie-wedge shape such that when moved rotationally via protrusion 48 it covers or opens openings 46, thereby regulating the flow of granulated material through element 322. The rate of flow may be set to a desired flow rate prior to connecting the flow-reducing element 322 with a container and cap. Alternatively, the cap may be provided with a slot that accommodates protrusion 48, such that the rate of flow may be adjusted by each user depending on their preference or depending upon the intended use. Those skilled in the art will understand that there are a variety of methods for adjusting the rate of flow through the flow-reducing element, of which only one is shown here.

In FIGS. 6 and 7, a flow-reducing element 422 is shown with an additional feature of a serrated or uneven surface or pyramidal protrusions 50 on its underside that aid in breaking up clumps of granulated material, such as salt or sugar that has clumped together. The size, shape, number and spacing of the protrusions may be varied and still accomplish the purpose. As a dispenser that includes element 422 is inverted and shaken, any clumps in the granular material will be broken by their momentum driving them into the protrusions 50. This avoids blockage of the openings through the flow-reducing element 422 and the associated cap by the clumps and reduces waste of the clumped material.

Presently preferred embodiments of the present invention have been described with a degree of particularity. The previous description is of preferred examples for implementing the invention, and the scope of the invention should not necessarily be limited by this description. The scope of the present invention is defined by the scope of the following claims.

1. A device for dispensing granulated or powdered material, comprising:
a container having a storage space for holding a supply of the material;
a cap portion covering and enclosing said container, said cap portion including a plurality of openings through which the material will flow to be dispersed when the container is inverted and shaken; and
a flow-reducing element located proximate to but spaced apart from the plurality of openings between said storage space and said openings, said flow-reducing element having a plurality of flow limiting holes through which the material must pass before flowing through the plurality of openings to be dispersed when the container is inverted and shaken.

2. The device of claim 1 where said flow-reducing element is removable from the device without the use of tools.

3. The device of claim 1 wherein said flow-reducing element comprises a screen and wherein said plurality of openings are provided through said screen.

4. The device of claim comprising a de-clumping protrusion on a surface of the flow-reducing element that faces generally towards said container.

5. The device of claim 1 where said flow-reducing element comprises a visible flange that protrudes beneath said cap.

6. The device of claim 1 where said flow-reducing element includes a pivoting shutter for reducing or increasing the amount of the material that can pass through the flow-reducing element.

7. The device of claim 1, wherein the plurality of holes includes a flow starting hole that is larger than the other holes in the plurality of holes, and wherein the flow starting hole is in axial alignment with an opening from the plurality of openings.

8. The device of claim 7, wherein the opening from the plurality of openings is located generally in the center of the cap portion.

9. The device of claim 8, wherein the device is a salt shaker, and wherein the flow starting hole has a diameter of approximately 1.34 mm and wherein the other holes in the plurality of holes have a diameter of about 1.1 mm.

10. A method of reducing the flow of granulated material from a dispenser of the type having a container for holding the granulated material and a perforated cap that includes a plurality of openings through an upper wall of the cap for dispersing and sprinkling granulated material when the device is inverted and shaken, the cap being selectively removable from an open end of said container, the method comprising:
providing a flow-reducing element between the opening of the container and an inside surface of the upper wall of the cap, such that an upper surface of the flow-reducing element is spaced apart from and approximately parallel to the upper wall's inside surface, said flow-reducing element restricting the flow of granulated material from the container to the plurality of openings when the dispenser is inverted and shaken.

11. The method of claim 10, wherein said flow-reducing element includes a plurality of holes for permitting flow of granulated material from the container to the plurality of openings.

12. The method of claim 11, wherein the surface area of the holes is less than the surface area of the openings.

13. A flow-reducing element for attachment to a salt shaker of the type that includes a container for holding a supply of salt and a perforated cap removably attached to the container for sprinkling salt when the salt shaker is inverted and shaken, the perforated cap having a top wall that includes a plurality of openings through which the salt flows when the salt shaker is inverted and shaken; the flow-reducing element comprising:
a barrier for operable connection to the salt shaker between the container and the top wall to substantially block the flow of salt from the container to the plurality of openings when the salt shaker is inverted and shaken; and
a plurality of holes through the barrier to permit the flow of salt from the container to the plurality of openings when the salt shaker is inverted and shaken.

14. The flow-reducing element of claim 13, wherein the barrier is a disk, further comprising a flange for creating an interference fit within the container.

15. The flow-reducing element of claim 13, wherein the plurality of holes includes at least three standard holes and one center hole, and wherein the center hole is larger than the standard holes.

16. The flow-reducing element of claim 15, wherein center hole aligns with an opening in the plurality of opening in the cap when the flow-reducing element is attached to the salt shaker in a working position.

17. The flow-reducing element of claim 13, wherein the plurality of holes are provided in a screen element that is mounted in the barrier.

18. The flow-reducing element of claim 13, wherein the barrier further comprises:
a generally flat disk portion in which the plurality of holes is provided;
an annular base extending beneath the disk for attaching the flow-reducing element to a salt shaker; and
a flange extending from the annular base for providing a visual indication that the flow-reducing element is attached to a salt shaker.

19. The flow-reducing element of claim 13, further comprising a shutter pivotally attached to the barrier for selectively blocking portion of the plurality of holes to adjust a flow rate through the barrier.

20. The flow-reducing element of claim 13, wherein the barrier has a top side for facing the openings and a bottom side for facing the supply of salt within the container; the barrier further including a pointed protrusion on the bottom side for breaking clumps of salt when the salt shaker is inverted and shaken.
